(19) United States
(12) Patent Application Publication
(10) Pub. No.: US 2022/0264072 A1
(43) Pub. Date: Aug. 18, 2022

(54) AUTO-CALIBRATING N-CONFIGURATION VOLUMETRIC CAMERA CAPTURE ARRAY

(71) Applicants: Sony Group Corporation, Tokyo (JP); Sony Pictures Entertainment, Inc., Culver City, CA (US)

(72) Inventors: Tobias Anderberg, Los Angeles, CA (US); David Bailey, Los Angeles, CA (US)

(21) Appl. No.: 17/405,790

(22) Filed: Aug. 18, 2021

Related U.S. Application Data
(60) Provisional application No. 63/148,764, filed on Feb. 12, 2021.

(51) Int. Cl. H04N 13/246; G06T 7/80; H04N 13/243; H04N 5/232

(52) U.S. Cl. CPC H04N 13/246; G06T 7/85; H04N 5/23218; H04N 5/23299; H04N 5/23212; H04N 13/243

(57) ABSTRACT

Machine vision and control including: instructing a plurality of imaging devices to capture or detect images to calibrate the plurality of imaging devices; recognizing the captured or detected images using machine vision or image recognition; determining a configuration of the plurality of imaging devices using the recognized images; and adjusting, positioning, aligning, and calibrating the plurality of imaging devices using the determined configuration.

### CROSS-REFERENCE TO RELATED APPLICATIONS

This application claims the benefit of priority under 35 U.S.C. § 119(e) of co-pending U.S. Provisional Patent Application No. 63/148,764, filed Feb. 12, 2021, entitled “Auto-Calibrating N-Configuration Volumetric Camera Capture Array.” The disclosure of the above-referenced application is incorporated herein by reference.

### BACKGROUND

### Field

The present disclosure relates to auto-calibrating imaging devices to known targets, or even using target-less auto-calibration, and imaging device arrays in any number of configurations.

### Background

Camera arrays for volumetric data capture requires very precise alignment and calibration of both cameras and lenses. However, the alignment and the calibration are not only reliant on the particular camera position relative to the capture subject, but also in relation to all the other cameras within the entire system in order to get the most accurate data capture possible.

### SUMMARY

The present disclosure provides for implementing a technique for auto-calibrating imaging devices to known targets, or even using target-less auto-calibration.

In one implementation, a machine-vision-and-control system is disclosed. The system includes: a machine vision system including a plurality of imaging devices to capture or detect one of (1) calibration target or (2) feature within a scene or capture volume; a processor to calibrate the plurality of imaging devices using the captured or detected calibration target or feature, and to determine a configuration of the plurality of imaging devices using machine vision or image recognition; and a control system including motorized device mounts on which the plurality of imaging devices is placed, wherein the processor adjusts, positions, aligns, and calibrates the motorized device mounts of the control system using the determined configuration of the plurality of imaging devices.

In one implementation, the processor automatically adjusts, positions, aligns, and calibrates the motorized device mounts of the control system. In one implementation, the processor automatically adjusts, positions, aligns, and calibrates lens parameters needed including focus and aperture. In one implementation, the control system manually activates or initiates a control process of the processor, wherein the control process includes adjusting, positioning, aligning, and calibrating. In one implementation, the processor continuously aligns and calibrates the control system according to defined conditions. In one implementation, the defined conditions include one of (1) when it is safe to do so, or (2) when the system is not recording any images. In one implementation, the motorized device mounts include one of (1) Brushless DC Motor (BLDC) or (2) Synchronous Servo Motor (SSVM). In one implementation, the control system further includes lenses electronically connected to the plurality of imaging devices.

In another implementation, a machine-vision-and-control method is disclosed. The method includes: instructing a plurality of imaging devices to capture or detect images to calibrate the plurality of imaging devices; recognizing the captured or detected images using machine vision or image recognition; determining a configuration of the plurality of imaging devices using the recognized images; and adjusting, positioning, aligning, and calibrating the plurality of imaging devices using the determined configuration.

In one implementation, the detected images include a calibration target. In one implementation, the detected images include a feature within a scene or capture volume. In one implementation, the method further includes adjusting, positioning, aligning, and calibrating lens parameters including focus and aperture. In one implementation, adjusting, positioning, aligning, and calibrating the plurality of imaging devices includes automatically adjusting, positioning, aligning, and calibrating the motorized device mounts on which the plurality of imaging devices is mounted. In one implementation, adjusting, positioning, aligning, and calibrating the plurality of imaging devices includes automatically adjusting, positioning, aligning, and calibrating lens parameters needed including focus and aperture. In one implementation, adjusting, positioning, aligning, and calibrating the plurality of imaging devices includes manually activating or initiating adjusting, positioning, aligning, and calibrating of the plurality of imaging devices. In one implementation, adjusting, positioning, aligning, and calibrating the plurality of imaging devices includes continuously aligning and calibrating the plurality of imaging devices according to defined conditions. In one implementation, the defined conditions include one of (1) when it is safe to do so, or (2) when the system is not recording any images.

In a further implementation, a non-transitory computer-readable storage medium storing a computer program to provide machine vision and control is disclosed. The computer program includes executable instructions that cause a computer to: instruct a plurality of imaging devices to capture or detect images to calibrate the plurality of imaging devices; recognize the captured or detected images using machine vision or image recognition; determine a configuration of the plurality of imaging devices using the recognized images; and adjust, position, align, and calibrate the plurality of imaging devices using the determined configuration.

Other features and advantages should be apparent from the present description which illustrates, by way of example, aspects of the disclosure.

### BRIEF DESCRIPTION OF THE DRAWINGS

The details of the present disclosure, both as to its structure and operation, may be gleaned in part by study of the appended drawings, in which like reference numerals refer to like parts, and in which:

FIG. 1A is a diagram of machine vision using scene feature detection for automatic calibration in accordance with one implementation of the present disclosure;

FIG. 1B is a diagram of machine vision using a specific high-precision calibration target in accordance with one implementation of the present disclosure;

FIG. 1C a side view of a control system including an imaging device mounted on a high-precision motorized platform showing automatic horizontal alignment in accordance with one implementation of the present disclosure;

FIG. 1D a top view of a control system including an imaging device mounted on a high-precision motorized platform showing automatic horizontal, fore and aft, and rotational alignment in accordance with one implementation of the present disclosure;

FIG. 2 is a diagram illustrating a machine vision and control system in accordance with one implementation of the present disclosure;

FIG. 3A is a block diagram of a machine vision and control system in accordance with one implementation of the present disclosure;

FIG. 3B is a flow diagram of a machine vision and control method in accordance with one implementation of the present disclosure;

FIG. 4A is a representation of a computer system and a user in accordance with an implementation of the present disclosure; and

FIG. 4B is a functional block diagram illustrating the computer system hosting the machine vision and control application in accordance with an implementation of the present disclosure.

### DETAILED DESCRIPTION

As described above, camera arrays for volumetric data capture requires very precise alignment and calibration of both cameras and lenses. However, the alignment and the calibration are not only reliant on the particular camera position relative to the capture subject, but also in relation to all the other cameras within the entire system in order to get the most accurate data capture possible. Therefore, a need exists for capturing and processing volumetric data and video streams from one or many imaging devices, such as a video capture system. A need also exists for auto-calibrating imaging devices to known targets, or even using target-less auto-calibration, and imaging device arrays in any number of configurations.

Certain implementations of the present disclosure provide for apparatus and methods including, but are not limited to, one or more of the following items: (a) visible calibration targets in a scene and machine vision system/method for detecting and calibrating the cameras to the targets; (b) machine vision feature detection in the scene and calibrating the cameras to targets; (c) high-precision motorized camera mounts for automatically re-orienting and re-positioning the camera based on the calibration phase; (d) an electronic lens and camera connection for automatically setting lens parameters, such as focus and aperture, based on the calibration phase; (e) camera arrays in various configurations (camera arrays 1n groups of three, with a combination or IR and color cameras, camera arrays have a single RGB-D sensor camera, camera arrays grouped together on “posts”, camera arrays in a spherical structure), such as one or combination of these configurations, providing an N-configuration system; and (f) a computer with software connected via ethernet, or other high-speed connectivity, for controlling this system.

After reading the below descriptions, it will become apparent how to implement the disclosure in various implementations and applications. Although various implementations of the present disclosure will be described herein, it is understood that these implementations are presented by way of example only, and not limitation. As such, the detailed description of various implementations should not be construed to limit the scope or breadth of the present disclosure.

In one implementation, a video capture system includes one or more imaging devices, each imaging device having a camera and lens, and other components for video capture, data storage and processing. The imaging devices may be mounted on high-precision motorized platforms, using motors such as Brushless DC Motor (BLDC) or Synchronous Servo Motor (SSVM) or other high-precision motors.

In one implementation, cameras and lenses include electronic connection and digital communication between them allowing for each camera to electronically set the lens parameters, such as focus, and aperture.

With the imaging devices mounted on high-precision motorized platforms, and with electronically connected lenses to cameras, a control system uses a machine vision system for automatically communicating with the cameras and the motorized platform for automatic alignment and calibration.

In one implementation, a machine vision system uses scene feature detection. In another implementation, the machine vision system uses specific high-precision calibration target images specific for the scene, to read and calibrate the system after image capture.

In one implementation, the machine vision system is part of a control system using a personal computer, tablet, or similar computing device. The control system reads the images from the imaging devices. It then uses machine vision or similar image recognition technologies to determine how the imaging devices and lens needs to be configured. Using this information, the control system automatically adjusts, positions, aligns, and calibrates the motorized device mounts, as well as any lens parameters needed, such as focus and aperture.

In one implementation, this control process is activated is manually initiated from the control system. In another implementation, the control process is an automated process where there is continuous alignment and calibration of the system according to defined conditions, such as when it is safe to do so, or when the system is not recording any images.

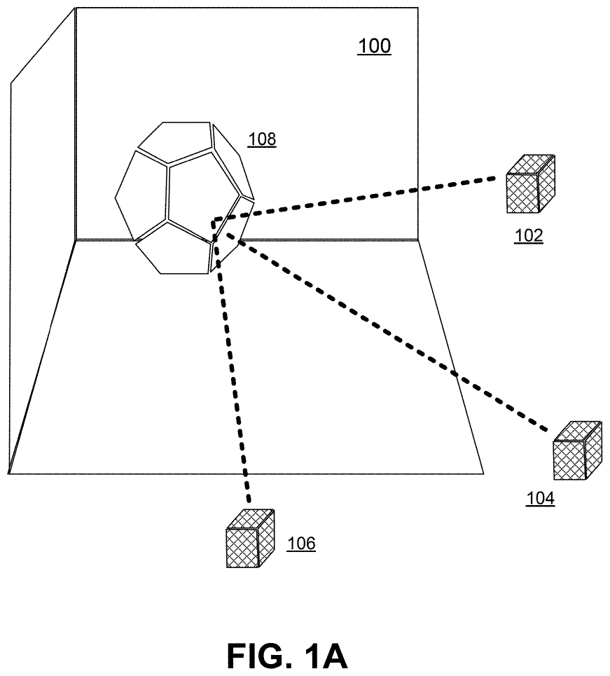

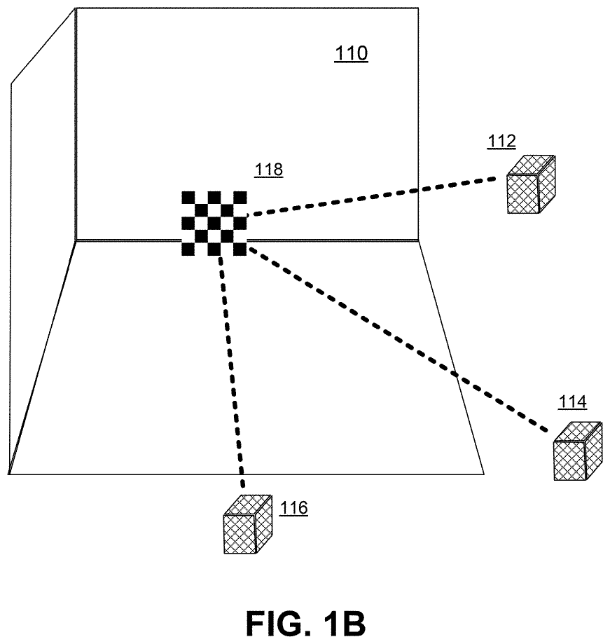

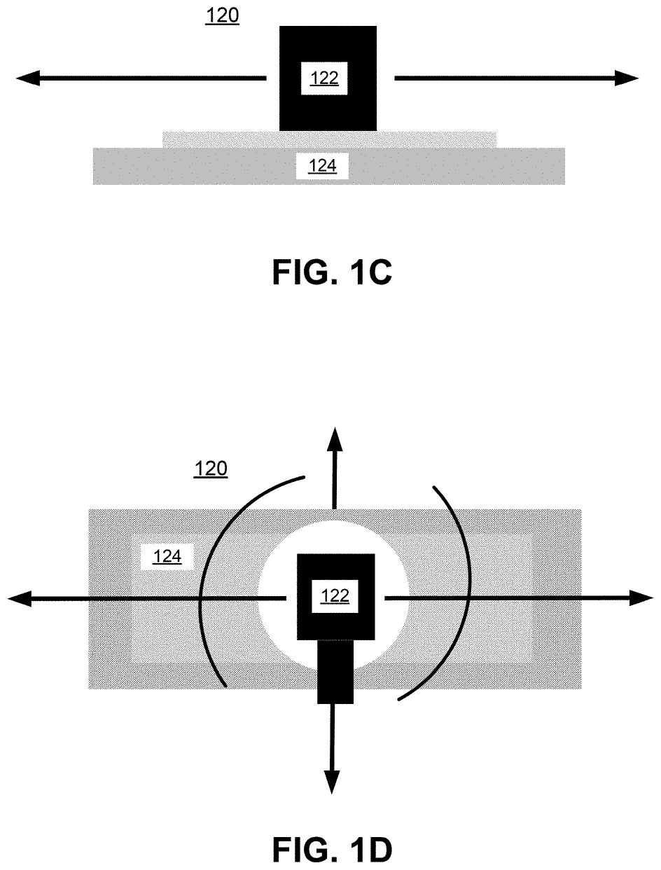

FIG. 1A is a diagram of machine vision 100 using scene feature detection in accordance with one implementation of the present disclosure. In the illustrated implementation of FIG. 1A, the machine vision 100 involves a plurality of imaging devices 102, 104, 106 configured to capture or detect a scene feature 108. In one implementation, the scene feature 108 is a feature that is found in a scene. In another implementation, the scene feature 108 is a feature that is placed within a scene. A machine vision system may then use the captured/detected scene feature 108 to calibrate the system including the plurality of imaging devices 102, 104, 106.

FIG. 1B is a diagram of machine vision 110 using a specific high-precision calibration target in accordance with one implementation of the present disclosure. In the illustrated implementation of FIG. 1B, the machine vision 110 involves a plurality of imaging devices 112, 114, 116 configured to capture or detect the specific high-precision calibration target 118. A machine vision system may then use the captured/detected high-precision calibration target 118 to calibrate the system including the plurality of imaging devices 112, 114, 116. In one implementation, the high-precision calibration target 118 is independent of the scene.

FIGS. 1C and 1D show a control system 120 including an imaging device 122 mounted on a high-precision motorized platform 124 in accordance with one implementation of the present disclosure. FIG. 1C is a side view of the control system 120 showing automatic horizontal alignment, while FIG. 1D is a top view of the control system 120 showing automatic horizontal, fore and aft, and rotational alignment and calibration. In one implementation, the high-precision motorized platform 124 is a 6-degree-of-freedom platform which provides left-right lateral movement, front-back lateral movement, and rotation movement.

In one implementation, the control system 120 further includes lenses (not shown) electronically connected to the imaging device 122. In another implementation, the control system 120 interfaces with a machine vision system for automatically communicating with the imaging device 122 and the motorized platform 124 for automatic alignment and calibration.

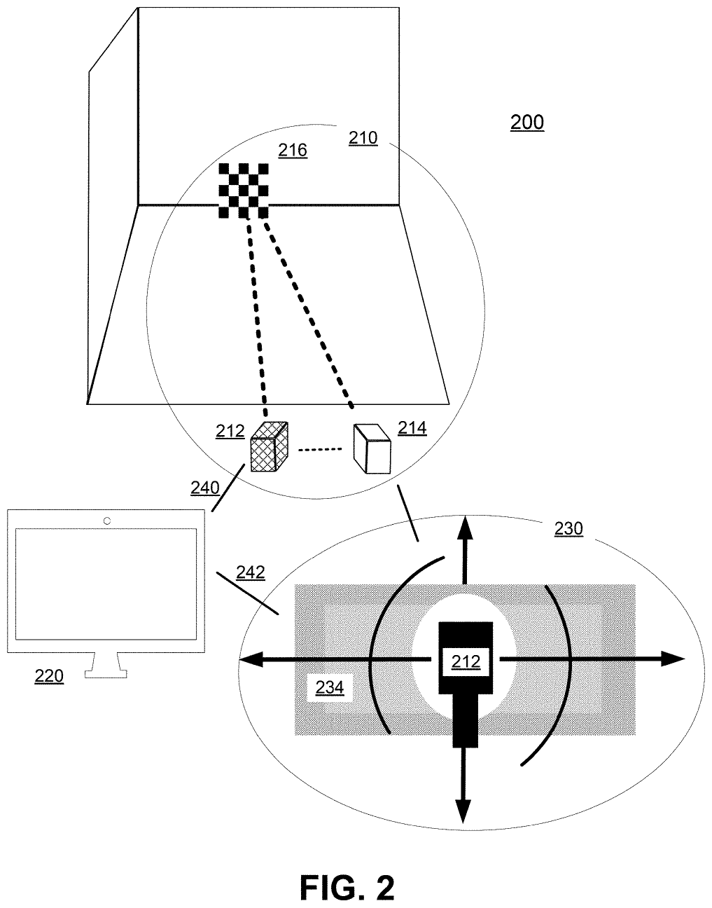

FIG. 2 is a diagram illustrating a machine vision and control system 200 in accordance with one implementation of the present disclosure. In the illustrated implementation of FIG. 2, the machine vision 210 involves a plurality of imaging devices 212, 214 configured to capture or detect a specific high-precision calibration target 216. In other implementations, the machine vision 210 may be configured to capture or detect a feature within a scene or capture volume. In one implementation, the imaging devices 212 and 214 are different types of devices, for example, an imaging device 212 is a camera, while an imaging device 214 is a lens.

In one implementation, the captured/detected high-precision calibration target 216 is used to calibrate the imaging devices 212, 214 residing within the machine vision and control system 200. In the illustrated implementation of FIG. 2, the calibration is performed using a personal computer, tablet, or similar computing device, collectively referred to as a calibration/control device 220. The calibration/control device 220 reads 240 images from the imaging devices 212, 214. The calibration/control device 220 then uses machine vision or similar image recognition technologies to determine how the imaging devices and lenses 212, 214 are to be configured. Using the determined information, the calibration/control device 220 automatically adjusts, positions, aligns, and calibrates 242 the control system 230 including the imaging device 212, the motorized device mount 234, as well as any lens parameters needed, such as focus and aperture.

In one implementation, the control process of the calibration/control device 220 is activated or initiated manually from the control system 230. In another implementation, the control process is an automated process where there is continuous alignment and calibration of the control system 230 according to defined conditions, such as when it is safe to do so, or when the system is not recording any images.

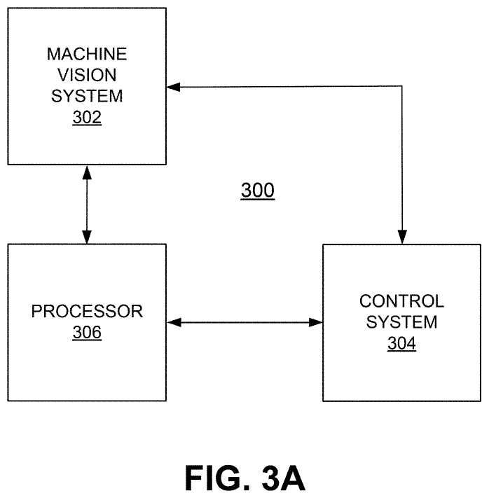

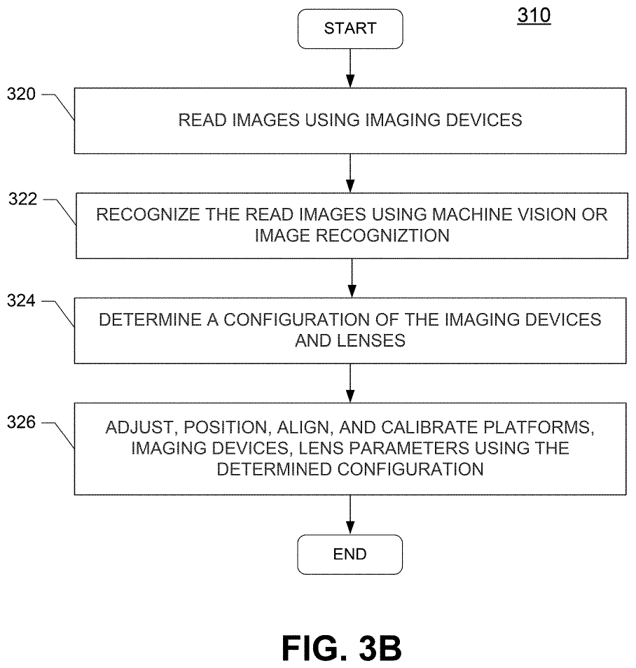

FIG. 3A is a block diagram of a machine vision and control system 300 in accordance with one implementation of the present disclosure. In one implementation, the machine vision and control system 300 is a generalization of the machine vision and control system 200. In the illustrated implementation of FIG. 3A, the machine vision and control system 300 includes machine vision system 302, a control system 304, and a processor 306.

In one implementation, the machine vision system 302 involves a plurality of imaging devices configured to capture or detect (1) a specific calibration target or (2) a feature within a scene or capture volume. In one implementation, the captured/detected calibration target is used to calibrate the imaging devices residing within the machine vision system 302.

In one implementation, the processor 306 performs the calibration by reading images from the imaging devices residing within the machine vision system 302. The processor 306 then uses machine vision or similar image recognition technologies to determine how the imaging devices and lenses are to be configured. Using the determined information, the processor 306 automatically adjusts, positions, aligns, and calibrates the control system including imaging devices, motorized device mounts, as well as any lens parameters needed, such as focus and aperture.

In one implementation, the control system 304 manually activates or initiates the control process of the processor 306. In another implementation, the control system 304 is continuously aligned and calibrated by the processor 306 according to defined conditions, such as when it is safe to do so, or when the system is not recording any images.

In one implementation, the control system 304 includes motorized platforms on which the imaging devices are placed. In one implementation, the motorized platform is a 6-degree-of-freedom platform which provides left-right lateral movement, front-back lateral movement, and rotation movement. In one implementation, the motorized platforms use motors such as Brushless DC Motor (BLDC) or Synchronous Servo Motor (SSVM) or other high-precision motors.

FIG. 3B is a flow diagram of a machine vision and control method 310 in accordance with one implementation of the present disclosure. In the illustrated implementation of FIG. 3B, the machine vision and control method 310 involves imaging devices capturing or detecting specific calibration target or feature within a scene or capture volume. In the illustrated implementation of FIG. 3B, the captured/detected calibration target or feature within the scene is used to calibrate the imaging devices residing within the machine vision and control system.

Initially, images are read, at step 320, by the imaging devices. The read images are recognized, at step 322, using machine vision or similar image recognition technologies. A configuration of the imaging devices and lenses is then determined, at step 324, using the recognized images. A control system, including motorized platforms on which the imaging devices are mounted as well as any lens parameters needed (e.g., focus and aperture), is adjusted, positioned, aligned, and calibrated, at step 326, using the determined configuration.

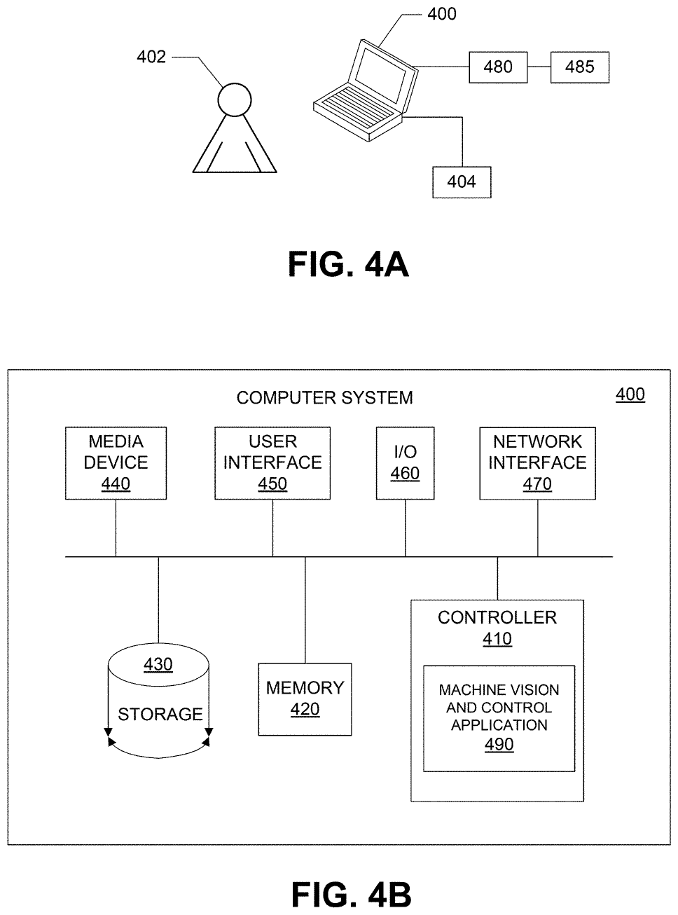

FIG. 4A is a representation of a computer system 400 and a user 402 in accordance with an implementation of the present disclosure. The user 402 uses the computer system 400 to implement an application 490 for machine vision and control as illustrated and described with respect to the system 300 in FIG. 3A and the method 310 in FIG. 3B.

The computer system 400 stores and executes the machine vision and control application 490 of FIG. 4B. In addition, the computer system 400 may be in communication with a software program 404. Software program 404 may include the software code for the machine vision and control application 490. Software program 404 may be loaded on an external medium such as a CD, DVD, or a storage drive, as will be explained further below.

Furthermore, the computer system 400 may be connected to a network 480. The network 480 can be connected in various different architectures, for example, client-server architecture, a Peer-to-Peer network architecture, or other type of architectures. For example, network 480 can be in communication with a server 485 that coordinates engines and data used within the machine vision and control application 490. Also, the network can be different types of networks. For example, the network 480 can be the Internet, a Local Area Network or any variations of Local Area Network, a Wide Area Network, a Metropolitan Area Network, an Intranet or Extranet, or a wireless network.

FIG. 4B is a functional block diagram illustrating the computer system 400 hosting the machine vision and control application 490 in accordance with an implementation of the present disclosure. A controller 410 is a programmable processor and controls the operation of the computer system 400 and its components. The controller 410 loads instructions (e.g., in the form of a computer program) from the memory 420 or an embedded controller memory (not shown) and executes these instructions to control the system, such as to provide the data processing. In its execution, the controller 410 provides the machine vision and control application 490 with a software system, such as to perform the visioning and control operations. Alternatively, this service can be implemented as separate hardware components in the controller 410 or the computer system 400.

Memory 420 stores data temporarily for use by the other components of the computer system 400. In one implementation, memory 420 is implemented as RAM. In one implementation, memory 420 also includes long-term or permanent memory, such as flash memory and/or ROM.

Storage 430 stores data either temporarily or for long periods of time for use by the other components of the computer system 400. For example, storage 430 stores data used by the machine vision and control application 490. In one implementation, storage 430 is a hard disk drive.

The media device 440 receives removable media and reads and/or writes data to the inserted media. In one implementation, for example, the media device 440 is an optical disc drive.

The user interface 450 includes components for accepting user input from the user of the computer system 400 and presenting information to the user 402. In one implementation, the user interface 450 includes a keyboard, a mouse, audio speakers, and a display. The controller 410 uses input from the user 402 to adjust the operation of the computer system 400.

The I/O interface 460 includes one or more I/O ports to connect to corresponding I/O devices, such as external storage or supplemental devices (e.g., a printer or a PDA). In one implementation, the ports of the I/O interface 460 include ports such as: USB ports, PCMCIA ports, serial ports, and/or parallel ports. In another implementation, the I/O interface 460 includes a wireless interface for communication with external devices wirelessly.

The network interface 470 includes a wired and/or wireless network connection, such as an RJ-45 or “Wi-Fi” interface (including, but not limited to 802.11) supporting an Ethernet connection.

The computer system 400 includes additional hardware and software typical of computer systems (e.g., power, cooling, operating system), though these components are not specifically shown in FIG. 4B for simplicity. In other implementations, different configurations of the computer system can be used (e.g., different bus or storage configurations or a multi-processor configuration).

The description herein of the disclosed implementations is provided to enable any person skilled in the art to make or use the present disclosure. Numerous modifications to these implementations would be readily apparent to those skilled in the art, and the principals defined herein can be applied to other implementations without departing from the spirit or scope of the present disclosure.

All features of each of the above-discussed examples are not necessarily required in a particular implementation of the present disclosure. Further, it is to be understood that the description and drawings presented herein are representative of the subject matter which is broadly contemplated by the present disclosure. It is further understood that the scope of the present disclosure fully encompasses other implementations that may become obvious to those skilled in the art and that the scope of the present disclosure is accordingly limited by nothing other than the appended claims.

1. A machine vision and control system comprising:
a machine vision system including a plurality of imaging devices to capture or detect one of (1) calibration target or (2) feature within a scene or capture volume;
a processor to calibrate the plurality of imaging devices using the captured or detected calibration target or feature, and to determine a configuration of the plurality of imaging devices using machine vision or image recognition; and
a control system including motorized device mounts on which the plurality of imaging devices is placed,
wherein the processor adjusts, positions, aligns, and calibrates the motorized device mounts of the control system using the determined configuration of the plurality of imaging devices.

2. The machine vision and control system of claim 1, wherein the processor automatically adjusts, positions, aligns, and calibrates the motorized device mounts of the control system.

3. The machine vision and control system of claim 1, wherein the processor automatically adjusts, positions, aligns, and calibrates lens parameters needed including focus and aperture.

4. The machine vision and control system of claim 1, wherein the control system manually activates or initiates a control process of the processor, wherein the control process includes adjusting, positioning, aligning, and calibrating.

5. The machine vision and control system of claim 1, wherein the processor continuously aligns and calibrates the control system according to defined conditions.

6. The machine vision and control system of claim 5, wherein the defined conditions include one of (1) when it is safe to do so, or (2) when the system is not recording any images.

7. The machine vision and control system of claim 1, wherein the motorized device mounts include one of (1) Brushless DC Motor (BLDC) or (2) Synchronous Servo Motor (SSVM).

8. The machine vision and control system of claim 1, wherein the control system further includes lenses electronically connected to the plurality of imaging devices.

9. A machine vision and control method comprising:
instructing a plurality of imaging devices to capture or detect images to calibrate the plurality of imaging devices;
recognizing the captured or detected images using machine vision or image recognition;
determining a configuration of the plurality of imaging devices using the recognized images; and
adjusting, positioning, aligning, and calibrating the plurality of imaging devices using the determined configuration.

10. The method of claim 9, wherein the detected images include a calibration target.

11. The method of claim 9, wherein the detected images include a feature within a scene or capture volume.

12. The method of claim 9, further comprising
adjusting, positioning, aligning, and calibrating lens parameters including focus and aperture.

13. The method of claim 9, wherein adjusting, positioning, aligning, and calibrating the plurality of imaging devices comprises
automatically adjusting, positioning, aligning, and calibrating the motorized device mounts on which the plurality of imaging devices is mounted.

14. The method of claim 9, wherein adjusting, positioning, aligning, and calibrating the plurality of imaging devices comprises
automatically adjusting, positioning, aligning, and calibrating lens parameters needed including focus and aperture.

15. The method of claim 9, wherein adjusting, positioning, aligning, and calibrating the plurality of imaging devices comprises
manually activating or initiating adjusting, positioning, aligning, and calibrating of the plurality of imaging devices.

16. The method of claim 9, wherein adjusting, positioning, aligning, and calibrating the plurality of imaging devices comprises
continuously aligning and calibrating the plurality of imaging devices according to defined conditions.

17. The method of claim 16, wherein the defined conditions include one of (1) when it is safe to do so, or (2) when the system is not recording any images.

18. A non-transitory computer-readable storage medium storing a computer program to provide machine vision and control, the computer program comprising executable instructions that cause a computer to:
instruct a plurality of imaging devices to capture or detect images to calibrate the plurality of imaging devices;
recognize the captured or detected images using machine vision or image recognition;
determine a configuration of the plurality of imaging devices using the recognized images; and
adjust, position, align, and calibrate the plurality of imaging devices using the determined configuration.

19. The storage medium of claim 18, wherein the executable instructions that cause the computer to adjust, position, align, and calibrate the plurality of imaging devices comprises executable instructions that cause the computer to
continuously align and calibrate the plurality of imaging devices according to defined conditions.

20. The storage medium of claim 18, wherein the detected images include a calibration target.
